(19) United States
(12) Patent Application Publication
(10) Pub. No.: US 2014/0272526 A1
(43) Pub. Date: Sep. 18, 2014

(54) POROUS SEPARATOR FOR A LITHIUM ION BATTERY AND A METHOD OF MAKING THE SAME

(71) Applicant: GM GLOBAL TECHNOLOGY OPERATIONS LLC, Detroit, MI (US)

(72) Inventor: Xiaosong Huang, Novi, MI (US)

(73) Assignee: GM GLOBAL TECHNOLOGY OPERATIONS LLC, Detroit, MI (US)

(21) Appl. No.: 13/828,352

(22) Filed: Mar. 14, 2013

(51) Int. Cl. H01M 2/16; H01M 2/14

(52) U.S. Cl. CPC H01M 2/16; H01M 2/1626; H01M 2/1686; H01M 2/145
USPC 429/144; 429/249; 429/255; 429/252; 429/246; 427/121

(57) ABSTRACT

A porous separator for a lithium ion battery is disclosed herein. The porous separator includes a non-woven membrane and a porous polymer coating. The porous polymer coating is formed on a surface of the non-woven membrane, or is infused in pores of the non-woven membrane, or is both formed on the surface of the non-woven membrane and infused in pores of the non-woven membrane.

### BACKGROUND

Secondary, or rechargeable, lithium ion batteries are often used in many stationary and portable devices such as those encountered in the consumer electronic, automobile, and aerospace industries. The lithium ion class of batteries has gained popularity for various reasons including a relatively high energy density, a general nonappearance of any memory effect when compared to other kinds of rechargeable batteries, a relatively low internal resistance, and a low self-discharge rate when not in use. The ability of lithium ion batteries to undergo repeated power cycling over their useful lifetimes makes them an attractive and dependable power source.

### SUMMARY

A porous separator for a lithium ion battery is disclosed herein. The porous separator includes a non-woven membrane and a porous polymer coating. The porous polymer coating is formed on a surface of the non-woven membrane, or is infused in pores of the non-woven membrane, or is both formed on the surface of the non-woven membrane and infused in pores of the non-woven membrane.

A lithium ion battery including the porous separator and a method for making the porous separator are also disclosed herein.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A and 1B are schematic, cross-sectional views which together illustrate an example of a method for making an example of a porous separator;

FIGS. 1A and 1C are schematic, cross-sectional views which together illustrate another example of the method for making another example of the porous separator;

FIGS. 1A and 1D are schematic, cross-sectional views which together illustrate still another example of the method for making still another example of the porous separator;

FIG. 2A is a schematic, cross-sectional view of yet another example of the porous separator including a ceramic layer on a surface of a non-woven membrane;

FIG. 2B is a schematic, cross-sectional view of yet another example of the porous separator including a ceramic layer infused in a non-woven membrane; and

FIG. 3 is a schematic, perspective view of an example of a lithium ion battery, including an example of the porous separator, during a discharging state.

### DETAILED DESCRIPTION

Lithium ion batteries often include a microporous polymer separator positioned between the positive electrode and the negative electrode. The microporous polymer separator should prevent the development of a direct electronic path between the positive electrode and the negative electrode, while also accommodating an electrolyte solution and enabling the passage of lithium ions. It has been found that some microporous polymer separators (e.g., free standing polymer layers, conventional polyethylene and polypropylene separators) exhibit poor tensile strength and/or become weak when exposed to the electrolyte solution and/or elevated temperatures. It has also been found that other microporous separators (e.g., non-woven, ceramic, etc.) may have pin holes, or other defects from manufacturing, which increase the risk of shorting.

Examples of the porous separator disclosed herein include a porous polymer coating on and/or in a porous non-woven membrane. The porous separator includes interconnected passages (i.e., pores) that extend through the thickness of the separator. These pores may be filled with a lithium ion-conducting electrolyte for transport of lithium ions through the separator. Since desirable separator/electrolyte wettability is obtained, the battery cycling performance is improved. Additionally, both the porous polymer coating and the non-woven membrane are formed of thermally stable materials, which improve the battery abuse tolerance of the separator. Further, the porous polymer coating of the separator is believed to cover any defects or pin holes that may be present in the membrane, thereby working to prevent shorting of a lithium ion battery that includes the porous separator. Still further, the porous non-woven membrane is believed to contribute to the overall strength of the separator, even at high temperatures.

In FIGS. 1B, 1C, and 2, the porous polymer coating is shown on one surface of the non-woven membrane. It is to be understood that the porous polymer coating may be formed on both the positive electrode facing surface and the negative electrode facing surface of the non-woven membrane, as shown in FIG. 3.

A method of making various examples of the porous separator includes coating a polymer solution on a non-woven membrane. The polymer solution coated membrane is shown in FIG. 1A.

The polymer solution 12 includes a polymer 14 dissolved in a solvent 16. Any polymer 14 having a melting temperature greater than or equal to 150° C. may be used. As examples, the polymer 14 may be polyetherimide (PEI), polysulfone, or polyvinylidene fluoride (PVDF). In addition, any suitable solvent 16 of the selected polymer 14 may be used. Examples of suitable solvents 16 include dimethylformamide (DMF), acetone, tetrahydrofuran (THF), dimethyl sulfoxide, or N-methylpyrrolidone (NMP). In one example, the polymer solution 12 also includes ceramic particles dispersed therein. These particles may be added to improve thermal, mechanical, and/or electrochemical performances of the resulting porous polymer coating 26 (see FIGS. 1B, 1C, and 1D). The ceramic particles have a size ranging from about 10 nm to about 10 μm. Examples of suitable ceramic particles that may be included in the polymer solution 12 include alumina, silica, titania, and calcium carbonate.

The polymer solution 12 may be made by mixing the polymer 14 into the solvent 16. In an example, the polymer concentration may range from about 2 wt % to about 50 wt %. In another example, the polymer concentration may range from about 10 wt % to about 25 wt %. If ceramic particles are used, the weight ratio of the ceramic to the polymer may be up to 200 wt % (i.e., 2:1). In any of the examples, the balance of the polymer solution 12 is made up of the solvent 16.

The non-woven membrane 18 is a network of fibers 20 with interconnected and open pores 22 formed between the fibers 20 and across the thickness T of the membrane 18. Examples of the fibers 20 are cellulose fibers, silica fibers (e.g., glass fibers), polyethylene terephthalate (PET) fibers, polyolefin fibers, polyacrylonitrile fibers, or polyamide fibers. Each fiber 20 has at least one dimension (e.g., diameter) on the nanoscale or the microscale (i.e., ranging from about 10 nm to about 5000 nm (5 μm)). Each pore 22 has a size (e.g., diameter) ranging from about 50 nm to about 20 μm. It is believed that the size of the pores 22 provides the membrane 18 with a smooth surface for coating, and also leads to enhanced adhesion with the subsequently formed porous polymer coating (see reference numeral 26 in FIGS. 1B, 1C, and 1D).

In an example, the non-woven membrane 18 may be made using a process that is similar to a process for making paper (i.e., a paper making process). For example, the fibers 20 may be dispersed in water and applied to a screen. The water is then removed and the remaining fibers become interconnected to form the porous network. In another example, the non-woven membrane 18 may be made by electrospinning, which uses an electrical charge to draw very fine fibers from a polymer solution.

As shown in FIG. 1A, the polymer solution 12 is coated on the surface S of the non-woven membrane 18. As noted previously, the polymer solution 12 may also be coated on the opposed surface S′. Coating of the polymer solution 12 may be accomplished using any suitable coating method, such as slot die coating, curtain coating, dip coating, etc.

After the surface(s) S, S′ have the polymer solution 12 applied thereon, the non-solvent concentration in the polymer solution 12 is increased. As an example, the solution coated membrane 24 may be introduced into an environmental chamber (not shown) in which the relative humidity is controlled to a desirable level. During humidity exposure, water is diffused into the polymer solution 12 layer. Since water is not a solvent of the selected polymer 14, the humidity exposure induces phase inversion (illustrated as “PI” on the arrows between FIG. 1A and each of FIGS. 1B, 1C, and 1D) of the polymer solution 12, and causes the polymer 14 to precipitate out of the solution 12. As a result of phase inversion, a gel-like structure is formed, which includes the precipitated polymer (shown as 14′ in FIGS. 1B, 1C, and 1D) as one phase and the solvent 16 and water as another phase.

The solvent 16 and any water are then removed (illustrated as “R” on the arrows between FIG. 1A and each of FIGS. 1B, 1C, and 1D), leaving the porous polymer coating 26, which includes the precipitated polymer 14′ and pores 28 formed in spaces previously occupied by the solvent 16 and/or water. Solvent 16 and/or water removal may be accomplished via any suitable method, such as evaporation and/or a washing process.

In another example of the method, the polymer solution 12 includes PVDF as the polymer 14, acetone as the solvent 16, and water as the non-solvent. This polymer solution 12 (containing the non-solvent), is applied to the non-woven membrane 18 using any of the coating processes previously described. The coated polymer solution 12 may then be exposed to evaporation. Acetone has a higher evaporation rate than water. As such, upon evaporation, the water (non-solvent) content in the polymer solution 12 increases and phase separation is induced. After phase separation, the water is removed, leaving the porous polymer coating 26.

The size of the pores 28 formed as a result of phase inversion may be controlled by the non-solvent concentration changing rate. In some examples, this may be controlled by controlling the relative humidity and/or the time of humidity exposure. In other examples, this may be controlled by controlling the evaporation rate of the solvent in the polymer solution. The desirable size for the pores 28 ranges from about 10 nm to about 3 μm. These pore sizes may be achieved, for example, by exposing a 15 wt % PEI solution in NMP to relative humidity of about 70% for about 20 seconds or to relative humidity of about 90% for about 5 seconds.

As shown in FIGS. 1B, 1C, and 1D, different examples of the porous separator 10, 10′, 10″ may be formed via the methods disclosed herein. For example, a bi-layer structure 10, 10′ may be formed (see FIGS. 1B and 1C) or a single layer structure 10″ may be formed.

As shown in FIG. 1B, the porous separator 10 includes the porous polymer coating 26 as a separate layer on the surface S of the non-woven membrane 18. In this example, the viscosity of the polymer solution 12 is high and the pore size of the membrane 18 is low, so the surface tension of the polymer solution 12 does not allow much, if any, of the polymer solution 12 to penetrate into the pores 22. As such, the polymer solution 12 remains on the surface S of the non-woven membrane 18. After phase inversion PI and solvent and/or non-solvent removal R are performed, the porous polymer coating 26 (including the precipitated polymer 14′ and pores 28) is formed on the surface S.

As shown in FIG. 1C, the porous separator 10′ includes the porous polymer coating 26 both on the surface S of the non-woven membrane 18 and in a portion of the non-woven membrane 18. In this example, some of the polymer solution 12 penetrates or infuses into some of the pores 22 while the rest of the polymer solution 12 remains on the surface S of the non-woven membrane 18. After phase inversion PI and solvent and/or non-solvent removal R are performed, the porous polymer coating 26 (including the precipitated polymer 14′ and pores 28) is formed on the surface S and in a portion of the non-woven membrane 18. In particular, the precipitated polymer 14′ and pores 28 are formed in the pores 22 penetrated by the polymer solution 12. Those pores 22 that were not infused with polymer solution 12 remain, as shown in FIG. 1C.

As shown in FIG. 1D, the porous separator 10″ includes the porous polymer coating 26 formed throughout the non-woven membrane 18. In this example, all of the polymer solution 12 penetrates or infuses into the pores 22 of the non-woven membrane 18 throughout the thickness T of the membrane 18. After phase inversion PI and solvent and/or non-solvent removal R are performed, the porous polymer coating 26 (including the precipitated polymer 14′ and pores 28) is formed in the non-woven membrane 18 but not on the surface S of the non-woven membrane 18. In particular, the precipitated polymer 14′ and pores 28 are formed in all of the pores 22 that had been penetrated by the polymer solution 12.

Any of the examples disclosed herein may also include a ceramic layer 29. The ceramic layer 29 may be formed on the surface S, S′ of the membrane 18 (see FIG. 2A), or may be infused into the pores 22 of the membrane 18 (see FIG. 2B), or may be both formed on the surface S, S′ of the membrane 18 and infused into the pores 22 of the membrane 18 (not shown). Whether the ceramic layer 29 forms on the surface S, S′ or is infused into the pores 22 depends upon the size of the particles and binder present in the ceramic layer 29 and the size of the pores 22.

It is to be understood that the ceramic layer 29 may be added to improve resistance to mechanical breaching, for example, by dendrites, metal fines, or detached electrode particles.

The ceramic layer 29 may be made up of a plurality of ceramic particles (e.g., silica, alumina, etc.) that are bound to one another with a polymer binder (e.g., polyacrylonitrile, PVDF, etc.). A dispersion used to form the ceramic layer 29 includes the particles, the binder, and a medium, such as DMF or NMP, which carries the particles and binder. The ceramic particles may fall within a predetermined size range. In an example, the maximum particle size is less 50% of the intended thickness of the ceramic layer 29. When two or more ceramic particles are layered, interconnected pores will form which can be filled with liquid electrolyte in the operating cell. In an example of forming the ceramic layer 29, 1 gram of polyacrylonitrile (PAN) is dissolved in 100 grams of DMF to form a 1 wt % solution. Into this solution, 65 grams of dried silica powder (300 nm) is added, and the mixture is stirred to form a substantially uniform dispersion. The silica dispersion is coated onto a non-woven membrane 18. The DMF is evaporated, and the ceramic layer 29 is formed.

In the example of the separator 10_{A} shown in FIG. 2A, the ceramic layer 29 is positioned on the non-woven membrane 18. In this example, a majority of the components (e.g., ceramic particles) of the ceramic layer 29 are larger than the size of the pores 22, and thus the ceramic layer 29 forms on the surface S, S′ of the membrane 18. It is to be understood that the ceramic particles in the layer 29 may have a size distribution, and thus some of the ceramic particles may be small enough to penetrate into the membrane 18 when the dispersion including the particles is applied to the surface S, S′. Although most of the ceramic particles do not penetrate into the pores 22 in this example, any polymer binder dissolved in the medium used for ceramic particle dispersion can diffuse into the pore(s) 22, thereby providing good adhesion between the ceramic layer 29 and the membrane 18.

In this example, the polymer solution 12 is applied over the ceramic layer 29. This keeps any ceramic particles in the ceramic layer 29 on the surface S, S′ from falling off of the membrane surface S, S′. The polymer solution 12 may also be able to wet (mix with) a portion of the ceramic layer 29 to provide good adhesion between the resulting porous polymer coating 26 and the ceramic layer 29.

While not shown, it is to be understood that the ceramic layer 29 includes interconnected pores therein.

In the example of the separator 10″_{A} shown in FIG. 2B, the ceramic layer 29 is positioned in the pores 22 of the non-woven membrane 18. In this example, the components of the ceramic layer 29 are as small as or smaller than the size of the pores 22, and thus the ceramic layer 29 penetrates into the membrane 18. In this example, the polymer solution 12 is applied and wets (mixes with) the ceramic layer 29 within the membrane 18. In this example, both the precipitated polymer 14′ and the ceramic layer 29 are present within the membrane 18 and the pores 28 may be formed within the pores 22 of the membrane 22 and/or within pores of the ceramic layer 29.

In any of the examples disclosed herein, the thickness of the resulting porous separator may range from about 15 μm to about 50 μm. In an example, the separator thickness ranges from about 15 μm to about 35 μm. In an example of the bi-layer separator 10, 10′, the membrane 18 has a thickness ranging from about 5 μm to about 25 μm and the porous polymer coating 26 has a thickness ranging from about 2 μm to about 25 μm.

Any of the examples of the porous separator 10, 10′, 10″, 10_{A}, 10″_{A} may be used in a lithium ion battery. One example of the lithium ion battery 30 is shown in FIG. 3. This example includes porous separator 10_{B}, which is similar to the separator 10, except that the porous polymer coating 26 is formed on each of the surfaces S and S′.

The battery 30 includes a cathode or positive electrode 32, and an anode or negative electrode 34. The porous separator 10_{B} is sandwiched between the two electrodes 32, 34, and an interruptible external circuit 36 connects the anode 34 and the cathode 32. Each of the anode 34, the cathode 32, and the porous separator 10_{B} may be soaked in an electrolyte solution capable of conducting lithium ions.

As mentioned above, the porous separator 10_{B}, which operates as both an electrical insulator and a mechanical support, is sandwiched between the anode 34 and the cathode 32 to prevent physical contact between the two electrodes 32, 34 and the occurrence of a short circuit. The porous separator 10_{B}, in addition to providing a physical barrier between the two electrodes 32, 34 may also provide a minimal resistance to the internal passage of lithium ions (Li⁺) to help ensure the lithium ion battery 30 functions properly. A negative-side current collector 34a and a positive-side current collector 32a may be positioned at or near the anode 34 and the cathode 32, respectively, to collect and move free electrons to and from the external circuit 36.

The lithium ion battery 30 may support a load device 38 that can be operatively connected to the external circuit 36. The load device 38 may be powered fully or partially by the electric current passing through the external circuit 36 when the lithium ion battery 30 is discharging. While the load device 38 may be any number of known electrically-powered devices, a few specific examples of a power-consuming load device include an electric motor for a hybrid vehicle or an all-electrical vehicle, a laptop computer, a cellular phone, and a cordless power tool, to name but a few. The load device 38 may also, however, be a power-generating apparatus that charges the lithium ion battery 30 for purposes of storing energy. For instance, the tendency of windmills and solar panel displays to variably and/or intermittently generate electricity often results in a need to store surplus energy for later use.

The lithium ion battery 30 may include a wide range of other components that, while not depicted here, are nonetheless known to skilled artisans. For instance, the lithium ion battery 30 may include a casing, gaskets, terminal caps, and any other desirable components or materials that may be situated between or around the anode 34, the cathode 32, and/or the porous separator 10_{B} for performance-related or other practical purposes. Moreover, the size and shape of the lithium ion battery 30 may vary depending on the particular application for which it is designed. Battery-powered automobiles and hand-held consumer electronic devices, for example, are two instances where the lithium ion battery 30 would most likely be designed to different size, capacity, and power-output specifications. The lithium ion battery 30 may also be connected in series and/or in parallel with other similar lithium ion batteries to produce a greater voltage output and current (if arranged in parallel) or voltage (if arranged in series) if the load device 38 so requires.

The lithium ion battery 30 can generate a useful electric current during battery discharge by way of reversible electrochemical reactions that occur when the external circuit 36 is closed to connect the anode 34 and the cathode 32 at a time when the anode 34 contains a sufficiently higher relative quantity of intercalated lithium (shown as black-filled circles). The chemical potential difference between the cathode 32 and the anode 34 (approximately 2.0 to 4.2 volts depending on the exact chemical make-up of the electrodes 32, 34) drives electrons produced by the oxidation of intercalated lithium at the anode 34 through the external circuit 36 towards the cathode 32. Lithium ions, which are also produced at the anode 34, are concurrently carried by the electrolyte solution through the porous separator 10_{B} and towards the cathode 32. The electrons flowing through the external circuit 36 and the lithium ions migrating across the porous separator 10_{B} in the electrolyte solution eventually reconcile and form intercalated lithium at the cathode 32. The electric current passing through the external circuit 36 can be harnessed and directed through the load device 38 until the intercalated lithium in the anode 32 is depleted (or the cathode 32 is fully intercalated) and the capacity of the lithium ion battery 30 is diminished.

The lithium ion battery 30 can be charged or re-powered at any time by applying an external power source to the lithium ion battery 30 to reverse the electrochemical reactions that occur during battery discharge. The connection of an external power source to the lithium ion battery 30 compels the otherwise non-spontaneous oxidation of intercalated lithium at the cathode 32 to produce electrons and lithium ions. The electrons, which flow back towards the anode 34 through the external circuit 36, and the lithium ions, which are carried by the electrolyte across the porous separator 10_{B} back towards the anode 34, reunite at the anode 34 and replenish it with intercalated lithium for consumption during the next battery discharge cycle. The external power source that may be used to charge the lithium ion battery 30 may vary depending on the size, construction, and particular end-use of the lithium ion battery 30. Some suitable external power sources include, but are not limited to, an AC wall outlet and a motor vehicle alternator.

The anode 34 may include any lithium host material that can sufficiently undergo lithium intercalation and deintercalation while functioning as the negative terminal of the lithium ion battery 13. The anode 34 may also include a polymer binder material to structurally hold the lithium host material together. For example, the anode 34 may be formed of an active material, made from graphite or a low surface area amorphous carbon, intermingled with a binder, made from polyvinylidene fluoride (PVdF), an ethylene propylene diene monomer (EPDM) rubber, or carboxymethyl cellulose (CMC). These materials may be mixed with a high surface area carbon, such as acetylene black, to ensure electron conduction between the current collector 34a and the active material particles of the anode 34. Graphite is widely utilized to form the anode 34 because it exhibits favorable lithium intercalation and deintercalation characteristics, is relatively non-reactive, and can store lithium in quantities that produce a relatively high energy density. Commercial forms of graphite that may be used to fabricate the anode 34 are available from, for example, Timcal Graphite & Carbon (Bodio, Switzerland), Lonza Group (Basel, Switzerland), or Superior Graphite (Chicago, Ill.,). Other materials can also be used to form the anode 34 including, for example, lithium titanate. The negative-side current collector 34a may be formed from copper or any other appropriate electrically conductive material known to skilled artisans.

The cathode 32 may be formed from any lithium-based active material that can sufficiently undergo lithium intercalation and deintercalation while functioning as the positive terminal of the lithium ion battery 30. The cathode 32 may also include a polymer binder material to structurally hold the lithium-based active material together. One common class of known materials that can be used to form the cathode 32 is layered lithium transitional metal oxides. In various examples, the cathode 32 may include an active material intermingled with a polymeric binder and mixed with a high surface area carbon, such as acetylene black, to ensure electron conduction between the current collector 32a and the active material particles of the cathode 32. The active material may be made of at least one of spinel lithium manganese oxide (LiMn₂O₄), lithium cobalt oxide (LiCoO₂), a nickel-manganese oxide spinel [Li(Ni_{0.5}Mn_{1.5})O₂], a layered nickel-manganese-cobalt oxide [Li(NiₓMn_{y}Co_{z})O₂], or a lithium iron polyanion oxide, such as lithium iron phosphate (LiFePO₄) or lithium iron fluorophosphate (Li₂FePO₄F). The polymeric binder may be made of at least one of polyvinylidene fluoride (PVdF), an ethylene propylene diene monomer (EPDM) rubber, or carboxymethyl cellulose (CMC)). Other lithium-based active materials may also be utilized besides those just mentioned. Examples of those alternative materials include lithium nickel-cobalt oxide (LiNiₓCo₁₋ₓO₂), aluminum stabilized lithium manganese oxide spinel (LiₓMn₂₋ₓAl_{y}O₄), and lithium vanadium oxide (LiV₂O₅). The positive-side current collector 32a may be formed from aluminum or any other appropriate electrically conductive material known to skilled artisans.

Any appropriate electrolyte solution that can conduct lithium ions between the anode 34 and the cathode 32 may be used in the lithium ion battery 30. In one example, the electrolyte solution may be a non-aqueous liquid electrolyte solution that includes a lithium salt dissolved in an organic solvent or a mixture of organic solvents. A list of example lithium salts that may be dissolved in an organic solvent to form the non-aqueous liquid electrolyte solution include LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, and mixtures thereof. These and other similar lithium salts may be dissolved in a variety of organic solvents such as, but not limited to, cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

To further illustrate the present disclosure, examples are given herein. It is to be understood that these examples are provided for illustrative purposes and are not to be construed as limiting the scope of the disclosed example(s).

### EXAMPLE

A porous separator was formed according to an example of the method disclosed herein. The separator was a bi-layer structure including the non-woven membrane made of micro-fibrillated cellulose fibers and the porous polymer coating made of polyetherimide. The total thickness of the separator was about 35 μm thick. A CELGARD 2500 separator having a thickness of 25 μm was used as a comparative example.

The separator and the comparative separator were saturated with a liquid electrolyte (1M LiPF₆ in ethylene carbonate/dimethyl carbonate (EC/DMC, 1:1 by volume)) and sandwiched between two stainless steel electrodes. The bulk resistances were measured on an impedance gain analyzer and the effective ionic conductivity values (σ_{eff}) were calculated. Thermal shrinkage was also measured in a thermal chamber. The temperature was maintained at 150° C. and the separator dimensional change was measure after 1 hour. These results are shown in Table 1.

TABLE 1

| | Comparative Sample | Sample |
|---|---|---|
| σ_{eff} (mS/cm) | 1.47 | 1.52 |
| Thermal shrinkage at 150° C. | 45% | 0% |

As illustrated, the Sample separator performed better than the Comparative Sample both in terms of ionic conductivity and thermal shrinkage. With regard to thermal shrinkage, the Sample separator exhibited no thermal shrinkage, which is particularly desirable.

It is to be understood that the ranges provided herein include the stated range and any value or sub-range within the stated range. For example, a range from about 50 nm to about 20 μm should be interpreted to include not only the explicitly recited limits of about 50 nm to about 20 μm, but also to include individual values, such as 75 nm, 550 nm, 10 μm, etc., and sub-ranges, such as from about 100 nm to about 15 μm; from about 1 μm to about 19 μm, etc. Furthermore, when “about” is utilized to describe a value, this is meant to encompass minor variations (up to +/−5%) from the stated value.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A porous separator for a lithium ion battery, comprising:
a non-woven membrane; and
a porous polymer coating i) formed on a surface of the non-woven membrane, or ii) infused in pores of the non-woven membrane, or iii) combinations of i and ii.

2. The porous separator as defined in claim 1 wherein the non-woven membrane is a network of polyamide fibers, cellulose fibers, silica fibers, polyethylene terephthalate fibers, polyolefin fibers, polyacrylonitrile fibers, or combinations thereof.

3. The porous separator as defined in claim 1 wherein a polymer of the porous polymer coating has a melting temperature that is greater than or equal to 150° C.

4. The porous separator as defined in claim 3 wherein the polymer is polyetherimide, polysulfone, or polyvinylidene fluoride.

5. The porous separator as defined in claim 1, further comprising a ceramic layer infused in the pores of the non-woven membrane, and wherein the porous polymer coating is infused in the pores of the ceramic layer.

6. The porous separator as defined in claim 1, further comprising a ceramic layer formed on the surface of the non-woven membrane, and wherein the porous polymer coating is formed on a surface of the ceramic layer.

7. The porous separator as defined in claim 1 wherein a thickness of the separator ranges from about 15 μm to about 50 μm.

8. The porous separator as defined in claim 1 wherein pores of the non-woven membrane have a diameter ranging from about 50 nm to about 20 μm.

9. A lithium ion battery, comprising:
a positive electrode;
a negative electrode;
a porous polymer separator disposed between the positive electrode and the negative electrode, the porous separator including:
a non-woven membrane; and
a porous polymer coating i) formed on a surface of the non-woven membrane, or ii) infused in pores of the non-woven membrane, or iii) combinations of i and ii.

10. The lithium ion battery as defined in claim 9 further comprising an electrolyte solution contacting at least the porous separator.

11. The lithium ion battery as defined in claim 9 wherein:
the non-woven membrane is a network of polyamide fibers, cellulose fibers, silica fibers, polyethylene terephthalate fibers, polyolefin fibers, polyacrylonitrile fibers, or combinations thereof; and
the polymer is polyetherimide, polysulfone, or polyvinylidene fluoride.

12. The lithium ion battery as defined in claim 9 wherein the porous separator further includes a ceramic layer.

13. A method for making a porous separator, the method comprising:
coating a polymer solution on a non-woven membrane;
increasing a non-solvent concentration in the polymer solution, thereby inducing phase inversion in the polymer solution and causing a polymer in the polymer solution to precipitate out of the polymer solution; and
removing any of a solvent or a non-solvent of the polymer solution, whereby a porous polymer coating is i) formed on a surface of the non-woven membrane, or ii) infused in pores of the non-woven membrane, or iii) combinations of i and ii.

14. The method as defined in claim 13 wherein prior to coating the polymer solution, the method further comprises making the non-woven membrane via a paper making process or an electrospinning process.

15. The method as defined in claim 13 wherein increasing the non-solvent concentration includes exposing the polymer solution coated on the non-woven membrane to a controlled level of humidity, thereby diffusing water into the polymer solution.

16. The method as defined in claim 15, further comprising controlling a time for the exposing of the polymer solution to the controlled level of humidity.

17. The method as defined in claim 13 wherein:
the non-woven membrane is a network of polyamide fibers, cellulose fibers, silica fibers, polyethylene terephthalate fibers, polyolefin fibers, polyacrylonitrile fibers, or combinations thereof; and
the polymer solution includes polyetherimide, polysulfone, or polyvinylidene fluoride as the polymer, and dimethylformamide, acetone, tetrahydrofuran, dimethyl sulfoxide, or N-methylpyrrolidone as the solvent.

18. The method as defined in claim 13, further comprising forming a ceramic layer on the non-woven membrane before coating the polymer solution on the non-woven membrane.

19. The method as defined in claim 18 wherein:
the polymer solution includes polyvinylidene fluoride as the polymer, acetone as the solvent, and water as the non-solvent; and
increasing the non-solvent concentration in the polymer solution is accomplished by evaporating the solvent.

20. The method as defined in claim 18 wherein:
the non-woven membrane is a network of polyamide fibers, cellulose fibers, silica fibers, polyethylene terephthalate fibers, or combinations thereof; and
the ceramic layer is formed by:
coating a dispersion of i) ceramic particles selected from silica particles or alumina particles, ii) a binder selected from polyacrylonitrile or polyvinylidene fluoride, and iii) a solvent selected from dimethylformamide or N-methylpyrrolidone on the non-woven membrane; and
removing the solvent.
